(19) United States
(12) Patent Application Publication
(10) Pub. No.: US 2023/0195764 A1
(43) Pub. Date: Jun. 22, 2023

(54) AUTOMATIC REAL-TIME INFORMATION AUGMENTATION FOR SUPPORT TICKETS

(71) Applicant: CrushBank Technology Inc., Syosset, NY (US)

(72) Inventor: David Tan, Glenwood Landing, NY (US)

(21) Appl. No.: 17/554,585

(22) Filed: Dec. 17, 2021

(51) Int. Cl. G06F 16/332; G06F 16/338

(52) U.S. Cl. CPC G06F 16/3329; G06F 16/338

(57) ABSTRACT

In an embodiment, a method includes identifying a support ticket for handling by a support agent, where the support ticket is associated in storage with a support message. The support message includes user-written text. The method also includes detecting non-user-written text in the support message and cleaning the support message. The cleaning includes removing the detected non-user-written text. The method also includes generating a query based, at least in part, on the cleaned support message. The method also includes causing the query to be executed on a data storage system that includes a first document repository and a second document repository. The method also includes receiving information identifying a first document from the first document repository and a second document from the second document repository. The method also includes publishing information related to the first document and the second document in relation to the support ticket.

### TECHNICAL FIELD

### Background

The present disclosure relates generally to user support and more particularly, but not by way of limitation, to systems and methods for automatic real-time information augmentation for support tickets.

### History of Related Art

Technical support typically involves a support agent interacting with one or more users. The efficiency and effectiveness of technical support is generally dependent on the skills of the support agent. Therefore, resolution of technical issues is often time-consuming and inconsistent.

### SUMMARY

A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions.

In an embodiment, one general aspect includes a method. The method includes identifying a support ticket for handling by a support agent, where the support ticket is associated in storage with a support message describing a basis for the support ticket. The support message includes user-written text. The method also includes detecting non-user-written text in the support message. The method also includes, responsive to the detecting, cleaning the support message. The cleaning includes removing the detected non-user-written text. The method also includes generating a query based, at least in part, on the cleaned support message. The method also includes causing the query to be executed on a data storage system that includes a first document repository and a second document repository. The method also includes, responsive to the causing, receiving information identifying a first document from the first document repository and a second document from the second document repository. The method also includes publishing, to the support agent, information related to the first document and the second document in relation to the support ticket. Other embodiments of this aspect include corresponding computer systems, apparatus, and computer programs recorded on one or more computer storage devices, each configured to perform the actions of the methods.

In an embodiment, another general aspect includes a computer system having a processor and memory. The processor and the memory in combination are operable to implement a method. The method includes identifying a support ticket for handling by a support agent, where the support ticket is associated in storage with a support message describing a basis for the support ticket. The support message includes user-written text. The method also includes detecting non-user-written text in the support message. The method also includes, responsive to the detecting, cleaning the support message. The cleaning includes removing the detected non-user-written text. The method also includes generating a query based, at least in part, on the cleaned support message. The method also includes causing the query to be executed on a data storage system that includes a first document repository and a second document repository. The method also includes, responsive to the causing, receiving information identifying a first document from the first document repository and a second document from the second document repository. The method also includes publishing, to the support agent, information related to the first document and the second document in relation to the support ticket.

In an embodiment, another general aspect includes a computer-program product. The computer-program product includes a non-transitory computer-usable medium having computer-readable program code embodied therein. The computer-readable program code is adapted to be executed to implement a method. The method includes identifying a support ticket for handling by a support agent, where the support ticket is associated in storage with a support message describing a basis for the support ticket. The support message includes user-written text. The method also includes detecting non-user-written text in the support message. The method also includes, responsive to the detecting, cleaning the support message. The cleaning includes removing the detected non-user-written text. The method also includes generating a query based, at least in part, on the cleaned support message. The method also includes causing the query to be executed on a data storage system that includes a first document repository and a second document repository. The method also includes, responsive to the causing, receiving information identifying a first document from the first document repository and a second document from the second document repository. The method also includes publishing, to the support agent, information related to the first document and the second document in relation to the support ticket.

### BRIEF DESCRIPTION OF THE DRAWINGS

A more complete understanding of the method and apparatus of the present disclosure may be obtained by reference to the following Detailed Description when taken in conjunction with the accompanying Drawings wherein:

FIG. 1 illustrates an example of a system for implementing a ticket management system.

FIG. 2 illustrates an example of a process for facilitating a technical support workflow via real-time information augmentation.

FIG. 3 illustrates an example of a computer system,

### DETAILED DESCRIPTION

Support tickets, also sometimes referred to as trouble tickets, incident tickets or the like, can be used to document and track handling of user problems in an information technology infrastructure. An agent can be tasked with investigating and resolving support tickets. Problematically, agent handling of support tickets is often repetitive, time-consuming, inconsistent, and inefficient. Agents may vary in technical expertise and their ability to find external resources that help resolve a given problem. Additionally, similar problems may be handled at different points of time, by different agents, with none of the agents having the benefit of earlier experiences by other agents.

The present disclosure describes examples of automatic real-time information augmentation for support tickets. In various embodiments, a query can be automatically generated from selected text in a message associated with a given support ticket. The text can be intelligently selected using one or more selection or filtering algorithms. The query can then be executed on a data storage system that includes multiple information or document repositories. In certain embodiments, the executed query yields highly relevant information from multiple data sources that augments the support ticket and enables improved handling by a responsible agent. Examples will be described below relative to the Drawings.

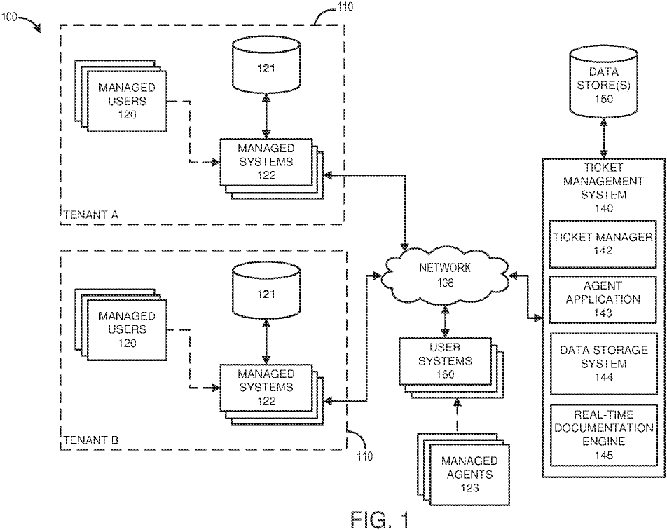

FIG. 1 illustrates an example of a system 100 for implementing a ticket management system 140 for support tickets. The system 100 includes the ticket management system 140, tenant systems 110, user systems 160 and one or more data stores 150, each of which is operable to communicate over a network 108. The network 108 may be, or include, one or more of a private network, a public network, a local or wide area network, a portion of the Internet, combinations of the same, and/or the like.

In some aspects, the ticket management system 140 can centrally manage support tickets for its tenants. In particular, in the system 100, the tenant systems 110 can be served by the ticket management system 140. In general, the tenant systems 110 can each be considered an abstraction of users supported by the ticket management system 140, and the systems and data sources with which those users interact. For example, one of the tenant systems 110 is shown as owned or operated by “Tenant A” while another system 110 is owned or operated by a different tenant, “Tenant B.” The tenant systems 110 shown can be owned or operated by the same or different entities. For example, Tenants A and B can represent customers (e.g., entities such as companies or individuals) of an operator of the ticket management system 140. Although the term “tenant” is used herein to describe the tenant systems 110 or owners/operators thereof, in addition to having its ordinary meaning, the term “tenant” can, but need not, refer to tenancy in a multitenant software architecture.

The tenant systems 110 are each shown to include one or more managed users 120, one or more computer systems 122 and one or more data sources 121. The one or more managed users 120 can correspond to tenant employees, for example. The one or more computer systems 122 can each provide an information technology infrastructure that includes, for example, a computing environment, inclusive of applications and corresponding user interfaces and dashboards, used by the managed users 120. As illustrated, any given one of the computer systems 122 may be operated by one of the managed users 120. In some cases, the computer systems 122 may represent desktop virtualization environments. In such cases, the managed users 120, for example, may operate the user systems 160 and access the desktop virtualization environments over the network 108.

The one or more data sources 121 of each of the tenant systems 110 can include data streams or datasets that can be received or processed by the computer systems 122. In various cases, the one or more data sources 121 can be updated by the computer systems 122, or other components, in real-time, on a periodic basis, e.g., according to a schedule, on-demand or a combination of the same. In various embodiments, the one or more data sources 121 of each of the tenant systems 110 can include, for example, configurations, knowledge bases with technical information and articles, tenant-specific repositories of support tickets, customer relationship management (CRM) systems, combinations of the foregoing and/or the like.

In the illustrated embodiment, the ticket management system 140 can include a ticket manager 142, an agent application 143, a real-time documentation engine 145, and a data storage system 144. Each of these components can be implemented with hardware and/or software, including (optionally) virtual machines and containers. In an example, the ticket management system 140 can be implemented as a single management server. In another example, the ticket management system 140 can be implemented in a plurality of virtual or physical servers, which may or may not be geographically co-located. In some embodiments, the ticket management system 140 and/or other aspects of the system 100 may be hosted on a cloud system.

In certain embodiments, features of the components of the ticket management system 140 can be made accessible over an interface to the user systems 160. The user systems 160 can include any type of computing device, including desktops, laptops, tablets, and smartphones, to name a few. The user systems 160 can be operated by users, such as the managed users 120 or the managed agents 123, or by other users, for example, for administration purposes. For illustrative purposes, the user systems 160 are shown as being operated by the managed agents 123. The managed agents 123 can be support agents that interact with the ticket management system 140 for purposes of handling and resolving, for example, support tickets for the managed users 120 of each of the tenant systems 110.

The ticket manager 142 can facilitate creation, storage, and retrieval of support tickets for each of the tenant systems 110. In various embodiments, each support ticket is associated in storage, such as the one or more data stores 150, with a support message describing a basis for the ticket. The support message can be, for example, an email or other message sent by one of the managed users 120 in which a problem is described. In various embodiments, the ticket manager 142 can interact with the managed users 120 in any suitable fashion to receive support messages, create support tickets based thereon, and store the support tickets in the data store(s) 150, for example.

The agent application 143 can interact with the managed agents 123 to manage a technical support workflow for support tickets. For example, in various embodiments, the agent application 143 can enable the managed agents 123 to select or identity support tickets for handling. In addition, or alternatively, the agent application 143 can integrate with other components of the ticket management system 140, such as the real-time documentation engine 145 described below, to enhance the technical support workflow.

The data storage system 144 can encompass an interface that provides access to data that may be queried or searched in connection with a given a support ticket. In some cases, the data storage system 144 can be an abstraction of data in such locations. For example, the data storage system 144 can provide an interface to, or be an abstraction of, the data sources 121, the data store(s) 150, and/or other data that may be internal or external to a given system.

In various embodiments, the real-time documentation engine 145 can identify real-time relevant information or documentation related to a selected or identified support ticket. In a typical embodiment, the real-time documentation engine 145 can clean the selected or identified support ticket, generate a query based thereon, and cause the data storage system to execute the query. In some embodiments, the query can be filtered, for example, via tenant-specific and/or user-specific filters that specify further cleaning of the selected or identified support ticket. In this way, the real-time documentation engine can identify relevant information or documents for the selected or identified support ticket. The real-time documentation engine 145 can provide or identify the relevant documents or other information to the agent application 143, which can result such data being published, for example, to a webpage, user dashboard, and/or the like. The web page, user dashboard or other UI(s) output, for example, by the real-time documentation engine 145 or the agent application 143, can be accessed the managed agents 123 via the user systems 160.

In general, the one or more data stores 150 can include any information collected, stored or used by the ticket management system 140. For example, in various embodiments, the one or more data stores 150 can include support tickets, filters for querying the data storage system 144 (e.g., on a tenant-specific and/or user-specific basis), metadata for support tickets or querying, data collected from the managed users 120, the managed agents 123 or the computer systems 122, combinations of the same and/or the like. In certain embodiments, data stored in the one or more data stores 150 can take the form of repositories, flat files, databases, etc.

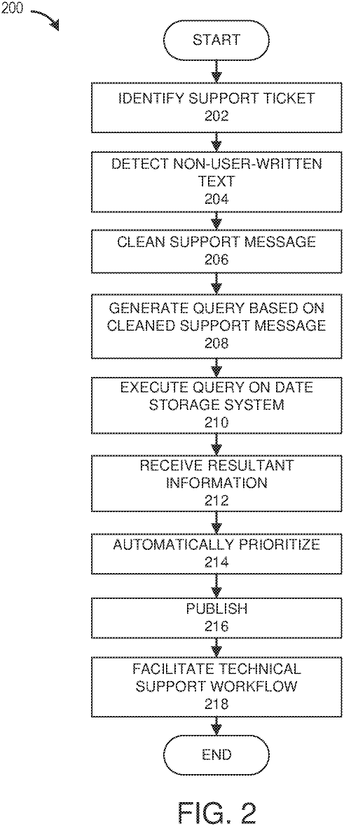

FIG. 2 illustrates an example of a process 200 for facilitating a technical support workflow via real-time information augmentation. In certain embodiments, the process 200 can be implemented by any system that can process data. Although any number of systems, in whole or in part, can implement the process 200, to simplify discussion, the process 200 will be described in relation to particular components shown and described relative to FIG. 1.

At block 202, the agent application 143 identifies a support ticket for handling by a support agent of the managed agents 123 The support ticket can be identified in any suitable fashion including, for example, by the support agent, a workflow management system, or the like. In a typical embodiment, the support ticket is associated in storage, such as in the data store(s) 150, with a support message that describes a basis for the support ticket. The support message can include, for example, user-written text that indicates a problem on the computer systems 122. In various cases, the support message can be an email, instant message, text message, transcription of an audio message, combinations of the foregoing and/or the like. The user-written text can be text entered by a user via an input device such as a physical or virtual keyboard, dictated text, text spoken to a virtual assistant, transcribed text from an audio message, combinations of the foregoing and/or the like.

At block 204, the agent application 143 causes the real-time documentation engine 145 to detect non-user-written text in the support message that is associated with the support ticket identified at the block 202. In certain embodiments, the real-time documentation engine 145 can execute an algorithm or a series of algorithms that detect, for example, boilerplate text in the support message. Examples of boilerplate text that might be detected at the block 204 include signatures (e.g., email signatures), legal disclaimers that are often appended to email messages and other messages, headers, footers, and/or any other text that is not considered part of the content of the support message.

At block 206, the real-time documentation engine 145 cleans the support message so as to yield a cleaned support message. The cleaning can include, for example, removing some or all of the non-user-written text detected at the block 204. In addition, or alternatively, the cleaning can include detecting stop words or noise words in the support message and removing the stop words or noise words.

At block 208, the real-time documentation engine 145 generates a query based, at least in part, on the cleaned support message. In general, the generating can involve assembling the query from some or all text of the cleaned support message. In some cases, the query can include only the text of the cleaned support message. In other cases, the query can include additions and/or deletions relative to the text of the clean support message.

For example, in some embodiments, generating the query can include applying one or more filters to the cleaned support message, such that some text from the cleaned support message is selectively excluded from the query. The filters can include, for example, tenant-specific filters. For example, a tenant-specific filter might remove specified terms or phrases that are ubiquitous in a given organization or that are otherwise deemed less relevant for that organization (e.g., a company name). The filters can also include, for example, user-specific filters. For example, a user-specific filter might involve removing specified terms or phrases that are common for the user or that are otherwise deemed less relevant for that user (e.g., a given user’s name, another name, etc.). In addition, or alternatively, generating the query can include adding text on a tenant-specific, user-specific, or general basis based on an analysis of the cleaned message.

At block 210, the real-time documentation engine 145 causes the query to be executed on the data storage system 144. As described previously, the data storage system 144 can provide an interface to, or be an abstraction of, multiple data sources or data stores. In general, the block 210 can involve the data storage system 144 executing the query on the multiple data sources and data stores, each of which can constitute a distinct information or document repository. In some cases, the query be revised, optimized and/or transformed according to the syntax of a data store, capabilities of a given data store, and/or other factors.

At block 212, the real-time documentation engine 145 receives, from the data storage system 144, resultant information from the query execution at the block 210. The resultant information can include, for example, identification of information or documents satisfying the query (or sufficiently satisfying the query), copies of such information or documents, an indication of a degree of relevance of each item of information or document, combinations of the foregoing and/or the like. In this way, the received information can relate to, or originate from, multiple data stores or other sources.

At block 214, the real-time documentation engine 145 automatically prioritizes the information or documents represented in the resultant information. For example, in some embodiments, the documents or information can be ranked and sorted by their relative relevance in any suitable fashion. In some embodiments, certain types of documents or information (e.g., other support tickets) might be given a higher priority than other types of documents (e.g., documents from a CRM system). In addition, or alternatively, certain information or documents may be given a higher priority based on a degree of match with the query (e.g., number of keyword matches) or other factors. In general, the information or documents can be prioritized in any suitable fashion. In some embodiments, the block 214 can be omitted.

At block 216, the agent application 143 publishes, to the support agent, information related to the resultant information in relation to the support ticket. At block 218, the agent application 143 facilitates a technical support workflow. The facilitating can include, for example, allowing the support agent to review the resultant information and/or any underlying information or documents. In addition, or alternatively, the agent application 143 can track various steps towards resolution of the support ticket. After block 218, the process 200 ends.

In various embodiments, a process such as the process 200 can be executed each time a support agent selects a support ticket. In this way, real-time documentation can be executed in real-time each time the support ticket is selected. In various embodiments, datasets frequently change. Therefore, advantageously, the real-time execution of queries as described above can pull real-time relevant information or documents for the support ticket, thereby reducing the time to resolution of support tickets and improving both technical support and system performance.

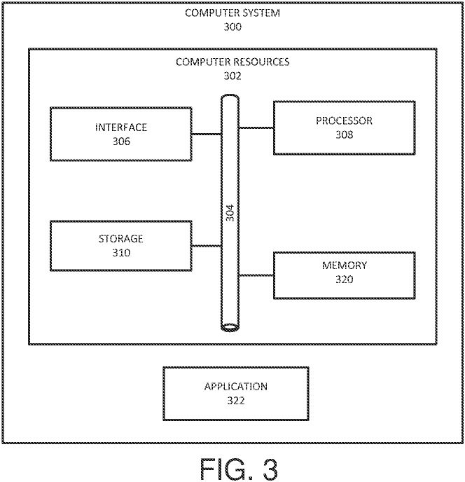

FIG. 3 illustrates an example of a computer system 300 that, in some cases, can be representative, for example, of the ticket management system 140, the tenant systems 110, the user systems 160 and/or a module or sub-component of the foregoing. The computer system 300 includes an application 322 operable to execute on computer resources 302. The application 322 can be, for example, any of the systems or modules illustrated in FIG. 1. In particular embodiments, the computer system 300 may perform one or more steps of one or more methods described or illustrated herein. In particular embodiments, one or more computer systems may provide functionality described or illustrated herein. In particular embodiments, encoded software running on one or more computer systems may perform one or more steps of one or more methods described or illustrated herein or provide functionality described or illustrated herein.

The components of the computer system 300 may comprise any suitable physical form, configuration, number, type and/or layout. As an example, and not by way of limitation, the computer system 300 may comprise an embedded computer system, a system-on-chip (SOC), a single-board computer system (SBC) (such as, for example, a computer-on-module (COM) or system-on-module (SOM)), a desktop computer system, a laptop or notebook computer system, an interactive kiosk, a mainframe, a mesh of computer systems, a mobile telephone, a personal digital assistant (PDA), a wearable or body-borne computer, a server, or a combination of two or more of these. Where appropriate, the computer system 300 may include one or more computer systems; be unitary or distributed; span multiple locations; span multiple machines; or reside in a cloud, which may include one or more cloud components in one or more networks.

In the depicted embodiment, the computer system 300 includes a processor 308, memory 320, storage 310, interface 306, and bus 304. Although a particular computer system is depicted having a particular number of particular components in a particular arrangement, this disclosure contemplates any suitable computer system having any suitable number of any suitable components in any suitable arrangement.

Processor 308 may be a microprocessor, controller, or any other suitable computing device, resource, or combination of hardware, software and/or encoded logic operable to execute, either alone or in conjunction with other components, (e.g., memory 320), the application 322. Such functionality may include providing various features discussed herein. In particular embodiments, processor 308 may include hardware for executing instructions, such as those making up the application 322. As an example, and not by way of limitation, to execute instructions, processor 308 may retrieve (or fetch) instructions from an internal register, an internal cache, memory 320, or storage 310; decode and execute them; and then write one or more results to an internal register, an internal cache, memory 320, or storage 310.

In particular embodiments, processor 308 may include one or more internal caches for data, instructions, or addresses. This disclosure contemplates processor 308 including any suitable number of any suitable internal caches, where appropriate. As an example, and not by way of limitation, processor 308 may include one or more instruction caches, one or more data caches, and one or more translation lookaside buffers (TLBs). Instructions in the instruction caches may be copies of instructions in memory 320 or storage 310 and the instruction caches may speed up retrieval of those instructions by processor 308. Data in the data caches may be copies of data in memory 320 or storage 310 for instructions executing at processor 308 to operate on; the results of previous instructions executed at processor 308 for access by subsequent instructions executing at processor 308, or for writing to memory 320, or storage 310; or other suitable data. The data caches may speed up read or write operations by processor 308. The TLBs may speed up virtual-address translations for processor 308. In particular embodiments, processor 308 may include one or more internal registers for data, instructions, or addresses. Depending on the embodiment, processor 308 may include any suitable number of any suitable internal registers, where appropriate. Where appropriate, processor 308 may include one or more arithmetic logic units (ALUs); be a multi-core processor; include one or more processors 308; or any other suitable processor.

Memory 320 may be any form of volatile or non-volatile memory including, without limitation, magnetic media, optical media, random access memory (RAM), read-only memory (ROM), flash memory, removable media, or any other suitable local or remote memory component or components. In particular embodiments, memory 320 may include random access memory (RAM). This RAM may be volatile memory, where appropriate. Where appropriate, this RAM may be dynamic RAM (DRAM) or static RAM (SRAM). Moreover, where appropriate, this RAM may be single-ported or multi-ported RAM, or any other suitable type of RAM or memory. Memory 320 may include one or more memories 320, where appropriate. Memory 320 may store any suitable data or information utilized by the computer system 300, including software embedded in a computer readable medium, and/or encoded logic incorporated in hardware or otherwise stored (e.g., firmware). In particular embodiments, memory 320 may include main memory for storing instructions for processor 308 to execute or data for processor 308 to operate on. In particular embodiments, one or more memory management units (MMUs) may reside between processor 308 and memory 320 and facilitate accesses to memory 320 requested by processor 308.

As an example, and not by way of limitation, the computer system 300 may load instructions from storage 310 or another source (such as, for example, another computer system) to memory 320. Processor 308 may then load the instructions from memory 320 to an internal register or internal cache. To execute the instructions, processor 308 may retrieve the instructions from the internal register or internal cache and decode them. During or after execution of the instructions, processor 308 may write one or more results (which may be intermediate or final results) to the internal register or internal cache. Processor 308 may then write one or more of those results to memory 320. In particular embodiments, processor 308 may execute only instructions in one or more internal registers or internal caches or in memory 320 (as opposed to storage 310 or elsewhere) and may operate only on data in one or more internal registers or internal caches or in memory 320 (as opposed to storage 310 or elsewhere).

In particular embodiments, storage 310 may include mass storage for data or instructions. As an example, and not by way of limitation, storage 310 may include a hard disk drive (HDD), a floppy disk drive, flash memory, an optical disc, a magneto-optical disc, magnetic tape, or a Universal Serial Bus (USB) drive or a combination of two or more of these. Storage 310 may include removable or non-removable (or fixed) media, where appropriate. Storage 310 may be internal or external to the computer system 300, where appropriate. In particular embodiments, storage 310 may be non-volatile, solid-state memory. In particular embodiments, storage 310 may include read-only memory (ROM). Where appropriate, this ROM may be mask-programmed ROM, programmable ROM (PROM), erasable PROM (EPROM), electrically erasable PROM (EEPROM), electrically alterable ROM (EAROM), or flash memory or a combination of two or more of these. Storage 310 may take any suitable physical form and may comprise any suitable number or type of storage. Storage 310 may include one or more storage control units facilitating communication between processor 308 and storage 310, where appropriate.

In particular embodiments, interface 306 may include hardware, encoded software, or both providing one or more interfaces for communication (such as, for example, packet-based communication) among any networks, any network devices, and/or any other computer systems. As an example, and not by way of limitation, communication interface 306 may include a network interface controller (NIC) or network adapter for communicating with an Ethernet or other wire-based network and/or a wireless NIC (WNIC) or wireless adapter for communicating with a wireless network.

Depending on the embodiment, interface 306 may be any type of interface suitable for any type of network for which computer system 300 is used. As an example, and not by way of limitation, computer system 300 can include (or communicate with) an ad-hoc network, a personal area network (PAN), a local area network (LAN), a wide area network (WAN), a metropolitan area network (MAN), or one or more portions of the Internet or a combination of two or more of these. One or more portions of one or more of these networks may be wired or wireless. As an example, computer system 300 can include (or communicate with) a wireless PAN (WPAN) (such as, for example, a BLUETOOTH WPAN), a WI-FI network, a WI-MAX network, an LTE network, an LTE-A network, a cellular telephone network (such as, for example, a Global System for Mobile Communications (GSM) network), or any other suitable wireless network or a combination of two or more of these. The computer system 300 may include any suitable interface 306 for any one or more of these networks, where appropriate.

In some embodiments, interface 306 may include one or more interfaces for one or more I/O devices. One or more of these I/O devices may enable communication between a person and the computer system 300. As an example, and not by way of limitation, an I/O device may include a keyboard, keypad, microphone, monitor, mouse, printer, scanner, speaker, still camera, stylus, tablet, touchscreen, trackball, video camera, another suitable I/O device or a combination of two or more of these. An I/O device may include one or more sensors. Particular embodiments may include any suitable type and/or number of I/O devices and any suitable type and/or number of interfaces 306 for them. Where appropriate, interface 306 may include one or more drivers enabling processor 308 to drive one or more of these I/O devices. Interface 306 may include one or more interfaces 306, where appropriate.

Bus 304 may include any combination of hardware, software embedded in a computer readable medium, and/or encoded logic incorporated in hardware or otherwise stored (e.g., firmware) to couple components of the computer system 300 to each other. As an example, and not by way of limitation, bus 304 may include an Accelerated Graphics Port (AGP) or other graphics bus, an Enhanced Industry Standard Architecture (EISA) bus, a front-side bus (FSB), a HYPERTRANSPORT (HT) interconnect, an Industry Standard Architecture (ISA) bus, an INFINIBAND interconnect, a low-pin-count (LPC) bus, a memory bus, a Micro Channel Architecture (MCA) bus, a Peripheral Component Interconnect (PCI) bus, a PCI-Express (PCI-X) bus, a serial advanced technology attachment (SATA) bus, a Video Electronics Standards Association local (VLB) bus, or any other suitable bus or a combination of two or more of these. Bus 304 may include any number, type, and/or configuration of buses 304, where appropriate. In particular embodiments, one or more buses 304 (which may each include an address bus and a data bus) may couple processor 308 to memory 320. Bus 304 may include one or more memory buses.

Herein, reference to a computer-readable storage medium encompasses one or more tangible computer-readable storage media possessing structures. As an example, and not by way of limitation, a computer-readable storage medium may include a semiconductor-based or other integrated circuit (IC) (such, as for example, a field-programmable gate array (FPGA) or an application-specific IC (ASIC)), a hard disk, an HDD, a hybrid hard drive (HHD), an optical disc, an optical disc drive (ODD), a magneto-optical disc, a magneto-optical drive, a floppy disk, a floppy disk drive (FDD), magnetic tape, a holographic storage medium, a solid-state drive (SSD), a RAM-drive, a SECURE DIGITAL card, a SECURE DIGITAL drive, a flash memory card, a flash memory drive, or any other suitable tangible computer-readable storage medium or a combination of two or more of these, where appropriate.

Particular embodiments may include one or more computer-readable storage media implementing any suitable storage. In particular embodiments, a computer-readable storage medium implements one or more portions of processor 308 (such as, for example, one or more internal registers or caches), one or more portions of memory 320, one or more portions of storage 310, or a combination of these, where appropriate. In particular embodiments, a computer-readable storage medium implements RAM or ROM. In particular embodiments, a computer-readable storage medium implements volatile or persistent memory. In particular embodiments, one or more computer-readable storage media embody encoded software.

Herein, reference to encoded software may encompass one or more applications, bytecode, one or more computer programs, one or more executables, one or more instructions, logic, machine code, one or more scripts, or source code, and vice versa, where appropriate, that have been stored or encoded in a computer-readable storage medium. In particular embodiments, encoded software includes one or more application programming interfaces (APIs) stored or encoded in a computer-readable storage medium. Particular embodiments may use any suitable encoded software written or otherwise expressed in any suitable programming language or combination of programming languages stored or encoded in any suitable type or number of computer-readable storage media. In particular embodiments, encoded software may be expressed as source code or object code. In particular embodiments, encoded software is expressed in a higher-level programming language, such as, for example, C, Perl, or a suitable extension thereof. In particular embodiments, encoded software is expressed in a lower-level programming language, such as assembly language (or machine code). In particular embodiments, encoded software is expressed in JAVA. In particular embodiments, encoded software is expressed in Hyper Text Markup Language (HTML), Extensible Markup Language (XML), or other suitable markup language.

Depending on the embodiment, certain acts, events, or functions of any of the algorithms described herein can be performed in a different sequence, can be added, merged, or left out altogether (e.g., not all described acts or events are necessary for the practice of the algorithms). Moreover, in certain embodiments, acts or events can be performed concurrently, e.g., through multi-threaded processing, interrupt processing, or multiple processors or processor cores or on other parallel architectures, rather than sequentially. Although certain computer-implemented tasks are described as being performed by a particular entity, other embodiments, are possible in which these tasks are performed by a different entity.

Conditional language used herein, such as, among others, “can,” “might,” “may,” “e.g.,” and the like, unless specifically stated otherwise, or otherwise understood within the context as used, is generally intended to convey that certain embodiments include, while other embodiments do not include, certain features, elements and/or states. Thus, such conditional language is not generally intended to imply that features, elements and/or states are in any way required for one or more embodiments or that one or more embodiments necessarily include logic for deciding, with or without author input or prompting, whether these features, elements and/or states are included or are to be performed in any particular embodiment.

While the above detailed description has shown, described, and pointed out novel features as applied to various embodiments, it will be understood that various omissions, substitutions, and changes in the form and details of the devices or algorithms illustrated can be made without departing from the spirit of the disclosure. As will be recognized, the processes described herein can be embodied within a form that does not provide all of the features and benefits set forth herein, as some features can be used or practiced separately from others. The scope of protection is defined by the appended claims rather than by the foregoing description. All changes which come within the meaning and range of equivalency of the claims are to be embraced within their scope.

What is claimed is:

1. A method comprising, by a computer system:
identifying a support ticket for handling by a support agent, wherein the support ticket is associated in storage with a support message describing a basis for the support ticket, the support message comprising user-written text;
detecting non-user-written text in the support message;
responsive to the detecting, cleaning the support message, the cleaning comprising removing the detected non-user-written text;
generating a query based, at least in part, on the cleaned support message;
causing the query to be executed on a data storage system comprising a first document repository and a second document repository;
responsive to the causing, receiving information identifying a first document from the first document repository and a second document from the second document repository; and
publishing, to the support agent, information related to the first document and the second document in relation to the support ticket.

2. The method of claim 1, wherein the cleaning comprises:
detecting one or more stop words in the support message; and
removing the stop words from the support message.

3. The method of claim 1, wherein the query comprises text of the cleaned support message.

4. The method of claim 1, comprising:
prior to the publishing, automatically prioritizing the first document and the second document; and
wherein the publishing comprises presenting the first document and the second document to the support agent in accordance with a result of the automatically prioritizing.

5. The method of claim 1, wherein the generating comprises:
applying a filter to the cleaned support message; and
assembling the query from text of the filtered cleaned support message.

6. The method of claim 1, comprising facilitating a technical support workflow responsive to the publishing.

7. The method of claim 1, wherein:
the detecting comprises detecting boilerplate text in the support message; and
the cleaning comprises removing the boilerplate text.

8. The method of claim 1, wherein:
the support message comprises an email;
the detecting comprises detecting an email signature in the support message; and
the cleaning comprises removing the email signature.

9. A computer system comprising a processor and memory, wherein the processor and the memory in combination are operable to implement a method comprising:
identifying a support ticket for handling by a support agent, wherein the support ticket is associated in storage with a support message describing a basis for the support ticket, the support message comprising user-written text;
detecting non-user-written text in the support message;
responsive to the detecting, cleaning the support message, the cleaning comprising removing the detected non-user-written text;
generating a query based, at least in part, on the cleaned support message;
causing the query to be executed on a data storage system comprising a first document repository and a second document repository;
responsive to the causing, receiving information identifying a first document from the first document repository and a second document from the second document repository; and
publishing, to the support agent, information related to the first document and the second document in relation to the support ticket.

10. The computer system of claim 9, wherein the cleaning comprises:
detecting one or more stop words in the support message; and
removing the stop words from the support message.

11. The computer system of claim 9, wherein the query comprises text of the cleaned support message.

12. The computer system of claim 9, the method comprising:
prior to the publishing, automatically prioritizing the first document and the second document; and
wherein the publishing comprises presenting the first document and the second document to the support agent in accordance with a result of the automatically prioritizing.

13. The computer system of claim 9, wherein the generating comprises:
applying a filter to the cleaned support message; and
assembling the query from text of the filtered cleaned support message.

14. The computer system of claim 9, the method comprising facilitating a technical support workflow responsive to the publishing.

15. The computer system of claim 9, wherein:
the detecting comprises detecting boilerplate text in the support message; and
the cleaning comprises removing the boilerplate text.

16. The computer system of claim 9, wherein:
the support message comprises an email;
the detecting comprises detecting an email signature in the support message; and
the cleaning comprises removing the email signature.

17. A computer-program product comprising a non-transitory computer-usable medium having computer-readable program code embodied therein, the computer-readable program code adapted to be executed to implement a method comprising:
identifying a support ticket for handling by a support agent, wherein the support ticket is associated in storage with a support message describing a basis for the support ticket, the support message comprising user-written text;
detecting non-user-written text in the support message;
responsive to the detecting, cleaning the support message, the cleaning comprising removing the detected non-user-written text;
generating a query based, at least in part, on the cleaned support message;
causing the query to be executed on a data storage system comprising a first document repository and a second document repository;
responsive to the causing, receiving information identifying a first document from the first document repository and a second document from the second document repository; and
publishing, to the support agent, information related to the first document and the second document in relation to the support ticket.

18. The computer-program product of claim 17, wherein the cleaning comprises:
detecting one or more stop words in the support message; and
removing the stop words from the support message.

19. The computer-program product of claim 17, wherein the query comprises text of the cleaned support message.

20. The computer-program product of claim 17, the method comprising:
prior to the publishing, automatically prioritizing the first document and the second document; and
wherein the publishing comprises presenting the first document and the second document to the support agent in accordance with a result of the automatically prioritizing.
